(19) United States
(12) Patent Application Publication
(10) Pub. No.: US 2025/0289346 A1
(43) Pub. Date: Sep. 18, 2025

(54) METHOD FOR CONTROLLING AN ELECTRIC MACHINE IN AN AT LEAST PARTIALLY ELECTRIFIED VEHICLE WHEN THE VEHICLE IS AT A STANDSTILL

(71) Applicant: ZF Friedrichshafen AG, Friedrichshafen (DE)

(72) Inventors: Patrick KROKER, Würzburg (DE); Johannes GÜRTLER, Lappersdorf (DE); Niklas BARTNECK, Konstanz (DE); Oliver DIETERLE, Kressbronn A. B. (DE)

(21) Appl. No.: 19/069,845

(22) Filed: Mar. 4, 2025

(30) Foreign Application Priority Data
Mar. 15, 2024 (DE) 10 2024 202 438.4

(51) Int. Cl. B60L 58/25; B60L 58/27

(52) U.S. Cl. CPC B60L 58/25; B60L 58/27; B60L 2210/42; B60L 2240/429

(57) ABSTRACT

A method for controlling an electric machine of an electric axle drive system in an at least partially electrified vehicle. The electric axle drive system has a converter device, particularly an inverter unit, upstream of the electric machine for voltage conversion. The method detects a standstill of the vehicle; receives a heat requirement signal of the vehicle which is at a standstill, which heat requirement signal indicates a heat requirement of at least one vehicle component of the vehicle; actuates the converter device, particularly the inverter unit to energize the electric machine such that a difference between a predefined reference value and an actual value of a total thermal load lies below a predefined threshold, and a thermal load difference between the individual phases of the electric axle drive system is minimized.

### BACKGROUND OF THE INVENTION

### 1. Field of the Invention

The disclosure is directed to a method for controlling an electric machine in an at least partially electrified vehicle, a corresponding apparatus or a corresponding control device, a corresponding electric axle drive system with the electric machine and the apparatus, an at least partially electrified vehicle with the electric axle drive system, and a corresponding machine-readable storage medium.

### 2. Description of Related Art

All-electric vehicles and hybrid vehicles that are driven exclusively by or supported by one or more electric machines as drive units are known from the prior art. To supply the electric machines of such electric vehicles or hybrid vehicles with electrical energy, the electric vehicles and hybrid vehicles comprise electrical energy storages, particularly rechargeable electric batteries or secondary batteries. These batteries are formed as DC voltage sources. However, electric machines generally need AC voltage. Therefore, a DC/AC inverter with semiconductor-based power electronics is connected between the battery and the electric machine of an electric vehicle or hybrid vehicle in order to convert the DC input voltage into an AC output voltage for energizing the electric machine.

Such inverters adjust predetermined voltages at windings or phases of the electric machine or three-phase machine by half-bridges. Two semiconductor-based power switches (high-side power switch and low-side power switch) are wired in series between different potentials of a DC link voltage in every half-bridge. The associated phase of the electric machine is contacted at that point where the two power switches are connected to one another. When the two power switches are alternately opened and closed with a predetermined duty cycle, such as according to a pulse width modulation, the desired phase voltage, particularly sinusoidal phase voltage, appears at the phase. In this way, the AC output voltage or phase voltages which are out of phase with one another can be generated at the windings of the electric machine from the DC input voltage of the battery. These phase voltages generate a rotating stator magnetic field which interacts with the magnetic field of the rotor and accordingly drives the rotor in rotational motion.

During operation of the electric machine, copper losses can occur on the machine side and switching losses can occur on the inverter side. Moreover, iron losses, friction losses, rotor copper losses, etc. can occur on the machine side during normal operation of the electric machine. Further, conduction losses can occur on the inverter side, while there is a preponderance of copper losses on the machine side with slowly rotating stator current phasor. If not efficiently dissipated, the heat generated as a result can lead to overheating of the inverter. At the same time, there are situations in which heat is additionally required. For example, it is useful to carry out a preconditioning of the drive battery in order to optimize its functionality for the desired driving operation. The preconditioning is carried out in that the drive battery is heated until a desired temperature has been reached. To improve range, such preconditioning of the (battery) system can preferably when parked at a charging station or charging column at low ambient temperatures. This does not obviate the need to not draw the energy required for preconditioning from the drive battery; rather, this energy can be drawn directly from the charging station. Alternatively or additionally, the generated heat can be utilized for heating the interior of the vehicle.

However, the disadvantage in the control method for electric machines which is known from the prior art consists in that, when feeding the phase currents into the electric machine for purposes of generating heat, the individual phases, particularly the various coil windings of the stator and the inverter components corresponding to the individual phases, are not uniformly heated. This leads to an asymmetrical thermal load between the individual phases in the electric machine and the electric axle drive overall, which can impair the functionality, and consequently also the life, of the electric axle drive.

### SUMMARY OF THE INVENTION

It is an object of one aspect of the invention to provide a method for controlling an electric machine in an at least partially electrified vehicle when the vehicle is at a standstill in order to generate the heat required by the vehicle when at a standstill, while optimizing the electric axle drive with respect to functionality and service life.

In a first aspect, the present invention is directed to a method and a corresponding apparatus for controlling an electric machine in an at least partially electrified vehicle when the vehicle is at a standstill.

The vehicle can be an all-electric vehicle or a hybrid vehicle. The electric axle drive system of the vehicle comprises an electric machine which is preferably formed as an asynchronous machine or externally excited synchronous machine or current-excited synchronous machine. The electric machine is preferably controlled by a field oriented control. The field oriented control allows the field-forming and torque-forming components, also known as d components and q components, to be decoupled, and the detected stator values are transformed into a rotating coordinate system (dq coordinate system).

To energize the electric machine which has (particularly, whose stator has) a plurality of coil windings, the electric axle drive system comprises a converter device, particularly a DC/AC inverter or inverter unit, which is connected between a drive battery (such as a high-voltage battery with a nominal voltage of 400 V or 800 V) and the electric machine. Accordingly, the inverter unit of the electric machine is connected upstream considered from the drive battery. The inverter unit serves to convert a DC input voltage supplied by the drive battery into an AC output voltage. To this end, the inverter unit has a DC link (or commutation circuit) with a DC link capacitor to which a DC link voltage is applied. The DC link capacitor can comprise an individual capacitor or an arrangement of a plurality of capacitor modules. The inverter unit additionally has a phase for each coil winding of the stator of the electric machine. The inverter unit is preferably multiphase, i.e., has a plurality of phases. Every phase comprises a plurality of semiconductor-based power switches which form a half-bridge. MOSFET-type, IGBT-type or other types of power switch can be selected. Silicon or a wide bandgap semiconductor (WBS) such as silicon carbide (SiC) or gallium nitride (GaN) can be used as the base semiconductor material for the power switches. In every half-bridge, a high-side device comprising one or more power switches (high-side power switches) connected in parallel and a low-side device comprising one or more power switches (low-side power switches) connected in parallel are wired in series between different potentials of the DC link voltage. The associated phase is contacted at that location where the high-side device and low-side device are connected to one another. When the high-side power switch and low-side power switch are alternately opened and closed with a predetermined duty cycle, the desired phase voltage occurs at the phase which is to be directed to the associated coil winding. In this way, time varying sinusoidal phase voltages which, taken as a whole, form the AC output voltage can be generated at the individual phases of the electric machine by a pulse width modulation (PWM) of the power switches.

The converter device can additionally comprise a DC/DC converter unit that likewise has power electronics with a half-bridge arrangement of the power switches and is configured to energize the rotor of the electric machine, the rotor preferably being formed as an electromagnet and the electric machine being formed, for example, as an externally excited or current-excited synchronous machine. Such a DC/DC converter unit can further be utilized to charge the drive battery in booster configuration, the same power electronics of the inverter unit being utilized for this purpose.

When the vehicle is at a standstill, it can happen that a vehicle component requires heat. For example, it can be useful or necessary to carry out a preconditioning of the drive battery to optimize its functionality with respect to the desired driving operation. This is carried out in that the drive battery is heated until it has reached a desired temperature. Alternatively or additionally, it can be useful or required to heat the vehicle interior by a corresponding heating device.

To this end, an apparatus is suggested according to one aspect of the invention for controlling the electric machine. The apparatus is preferably formed as a control device which can be an electronic control unit (ECU) of the vehicle or, alternatively, can be integrated in the ECU or, as another alternative, can be signally connected to the ECU. The apparatus is configured to carry out a method or control method for the electric machine.

The method comprises detecting the standstill state of the vehicle. This can be carried out in that the ECU of the vehicle sends a corresponding standstill signal to the apparatus according to the invention, this standstill signal being generated as soon as the vehicle is brought to a standstill.

The method further comprises receiving a heat requirement signal of the vehicle which is at a standstill. The heat requirement signal indicates a heating requirement of a vehicle component of the vehicle. The vehicle component is, for example, the drive battery which is to undergo a preconditioning. The heat requirement signal can be generated, for example, when the temperature of the drive battery or the outside temperature or ambient temperature (i.e., the temperature of the environment of the vehicle) which is monitored, for example, lies below a predefined lower limit. Alternatively or additionally, the at least one vehicle component can comprise a vehicle interior heating device. The heat requirement signal can be generated in this case, for example, when the temperature of the vehicle interior is below a predefined temperature threshold. As a further alternative or additionally, the heat requirement signal can be generated when a predefined time period has elapsed after the vehicle has first come to a standstill. The heat requirement signal can be a temporal point signal, a temporal (e.g., periodic) signal sequence or, alternatively, a temporal continuous signal. The configurations mentioned above with respect to the vehicle components and the heat requirement signal are merely illustrative and are not limiting for the present invention. The heat requirement signal can be actively detected by the apparatus according to one aspect of the invention (or control device according to one aspect of the invention) or can be passively conveyed to the apparatus or control device as signals that have already been detected.

Subsequently, the converter device, particularly the inverter unit, is actuated to energize the electric machine. In so doing, the power switches of the converter device or inverter unit are alternately opened and closed so that phase currents result during which the individual phases of the electric machine, particularly the coil windings of the stator (stator windings) associated with the phases and the converter device or inverter unit, are uniformly thermally loaded. To this end, the thermal loads of the various phases are preferably determined on the machine side and/or converter side or inverter side. In a first approximation, the copper losses for the machine-side thermal loads or switching losses and/or conduction losses for the converter-/inverter-side thermal loads of the phases are measured and/or calculated. A total thermal load of the electric axle drive system is obtained from the machine-side and/or inverter-side thermal loads determined in this way. Subsequently, the inverter unit is actuated such that the total thermal load corresponds to a reference value. The reference value describes the requested total thermal load of the electric axle drive system which preferably corresponds to the detected heat requirement. To this end, a difference between an actual value and the reference value of the total thermal load can be determined. Based on the difference between actual value and reference value, the power switches of the converter device or inverter unit are correspondingly switched and, consequently, the phase currents are adapted until the reference value is reached.

Further, a thermal load difference between individual phases of the electric axle drive system are minimized (on the machine side and/or converter side or inverter side) by switching the power switches. A difference in thermal loads between the individual phases is determined as thermal load difference. This thermal load difference is preferably minimized, further preferably reduced to and held at zero, by a controlled rotation of a current phasor corresponding to the phase currents of the electric machine in a dq coordinate system. The minimizing process involves switching the power switches according to a corresponding suitable switching pattern.

The heat generated in the inverter unit and in the electric machine, particularly in the stator windings, by energizing the stator is delivered to the at least one vehicle component to cover its heat requirement. The heat is used, for example, for preconditioning the drive battery. The transfer of heat can be carried out via the coolant circuit of the electric axle drive system. In this regard, the coolant present in the coolant circuit of the electric machine or converter device (inverter unit) is heated, whereupon its temperature increases. If the same coolant circuit is simultaneously used for cooling the drive battery or, alternatively, is thermally coupled with a separate coolant circuit of the drive battery via a heat exchanger, the heat generated according to the invention can also be supplied to the drive battery so as to selectively heat the latter for the purpose of preconditioning. This also applies analogously to the case in which the at least one vehicle component comprises the vehicle interior heating device or another or further component to be heated.

According to one aspect of the invention, the electric axle drive system can be operated in the manner described above in order to bring about a selective heat generation. This is achieved without the need for an additional heating source, which facilitates a compact and power-efficient electric axle drive system. Component parts already existing in the electric axle drive system, particularly the electric machine and the converter device or inverter unit, are used for generating heat, and the process of heat generation is easy to initiate and is surveyable in a highly reliable manner. At the same time, the standstill of the vehicle is ensured in that the stator magnetic field is selectively adjustable to keep the torque on the rotor below the predefined upper limit. In particular, this is provided without sacrificing the life of the electric machine and converter device or inverter unit due to uneven thermal loads between the phases. Further, an unnecessary use of heat is prevented in this way because heat generation is not initiated until the heat requirement signal has been received. The efficient use of energy of the electric axle drive system and of the vehicle as a whole is therefore increased.

According to an aspect of the invention, the converter device, particularly the inverter unit, is actuated to generate the stator magnetic field such that its rotational frequency (angular frequency) lies below a predefined first threshold frequency. This enables a low angular frequency for the adjusted stator magnetic field so that the torque acting on the rotor (or on the motor shaft of the electric machine) is kept at a comparatively low level. In this regard, copper losses on the machine side occur substantially primarily in the stator windings. The copper losses, moreover, are substantially equal over the period duration of the stator magnetic field corresponding to the angular frequency averaged over all of the phases. This enables, in addition, a uniform (and symmetrical) thermal loading of the multi-phase system in the electric machine and in the converter device or inverter unit. Beyond this, a further advantage is provided because the stator can generally be cooled appreciably better at a standstill than, e.g., the rotor, particularly using an oil cooling of the electric machine, and the copper losses in the system overall can therefore be extensively dissipated. Contemplated values for the predefined first threshold frequency are, for example, less than 1 Hz, preferably less than 0.5 Hz, further preferably less than 0.1 Hz, even further preferably less than 0.01 Hz, still further preferably less than 0.005 Hz. Such threshold frequency values (or value ranges) preferably also apply to the above-mentioned rotation of the current phasor in the dq coordinate system.

According to a further aspect, the converter device, particularly the inverter unit, is actuated to generate an AC output voltage based on a DC input voltage, which AC output voltage corresponds to a voltage phasor rotating relative to a rotor coordinate system with a second rotational frequency, which second rotational frequency lies below a predefined second threshold frequency. Alternatively or additionally, the converter device, particularly the inverter unit, is actuated to generate a plurality of AC phase currents based on a DC input voltage, which AC phase currents correspond to a current phasor rotating relative to a dq coordinate system with a third rotational frequency, which third rotational frequency lies below a predefined third threshold frequency. The second rotational frequency and/or third rotational frequency preferably correspond to or are identical to the first rotational frequency of the stator magnetic field. The second threshold frequency and/or the third threshold frequency preferably correspond to or are identical to the first threshold frequency. In this case, the above-mentioned exemplary threshold frequency values (or value ranges) are further preferably also applicable to the second threshold frequency and/or third threshold frequency. Here also, an improved uniformity of the thermal loading of the individual phasors is achievable.

According to a further preferred aspect, the rotation of the stator magnetic field results with the first rotational frequency and/or the rotation of the voltage phasor with the third rotational frequency based directly on the rotation of the current phasor with the second rotational frequency. In particular, by adjusting the phase currents on the input side of the utilized plant, the second rotational frequency of the current phasor can be used as control variable in order to generate the third rotational frequency of the voltage phasor or the first rotational frequency of the stator magnetic field on the output side of the plant. In this case, the first rotational frequency and/or the third rotational frequency are directly coupled with the second rotational frequency or are identical to the latter.

One aspect of the invention is further directed to the electric axle drive system for an at least partially electrified vehicle that comprises an electric machine, a converter device (particularly an inverter unit) upstream of the electric machine for voltage conversion, and the above-described apparatus (control device) according to the invention. The invention is further directed to the at least partially electrified vehicle with the electric axle drive system according to one aspect of the invention and a machine-readable (storage) medium comprising commands which, when executed by a computer, cause the computer to implement the steps of the method according to one aspect of the invention in accordance with any one of the embodiment forms described herein. As a result, the advantages which have already been described in connection with the method according to the invention are also provided for the apparatus according to the invention, the electric axle drive system according to the invention, the vehicle according to the invention and the (storage) medium according to the invention.

### BRIEF DESCRIPTION OF THE DRAWINGS

The invention will be described in the following by way of example referring to embodiment forms shown in the drawings.

The drawings show:

FIG. 1 is a schematic diagram of an electric axle drive system for an at least partially electrified vehicle having an electric machine and a converter device upstream of the electric machine;

FIG. 2 is a schematic wiring diagram of an inverter unit which is switched for purposes of heat generation by the electric machine when the vehicle is at a standstill;

FIG. 3 is a schematic depiction of a method for controlling the electric machine for purposes of heat generation when the vehicle is at a standstill; and

FIG. 4 is a schematic depiction of a further method for controlling the electric machine for purposes of heat generation when the vehicle is at a standstill.

### DETAILED DESCRIPTION OF THE PRESENTLY PREFERRED EMBODIMENTS

Like objects, functional units and comparable components are designated by like reference characters throughout the drawings. These objects, functional units and comparable components are identically configured with respect to the technical features thereof unless otherwise explicitly or implicitly stated in the description.

FIG. 1 is a schematic diagram showing an exemplary, at least partially electrified vehicle 100. The vehicle 100 can be formed as an all-electric vehicle or as a hybrid vehicle. Vehicle 100 has an electric axle drive system 101 with an electric machine 116, a converter device 121 and a gearbox 112. The converter device 121 is arranged upstream of the electric machine 116 with reference to a power transmission direction of the electric axle drive system 101 (i.e., from a drive battery 120 to wheels 102, 104). The gearbox 112 is arranged downstream of the electric machine 116 with reference to the power transmission direction of the electric axle drive system 101. The gearbox 112 is preferably a single stage gearbox or a reduced gearbox for transmitting power from the electric machine 116, particularly from a rotor of the electric machine 116, to the wheels 102, 104.

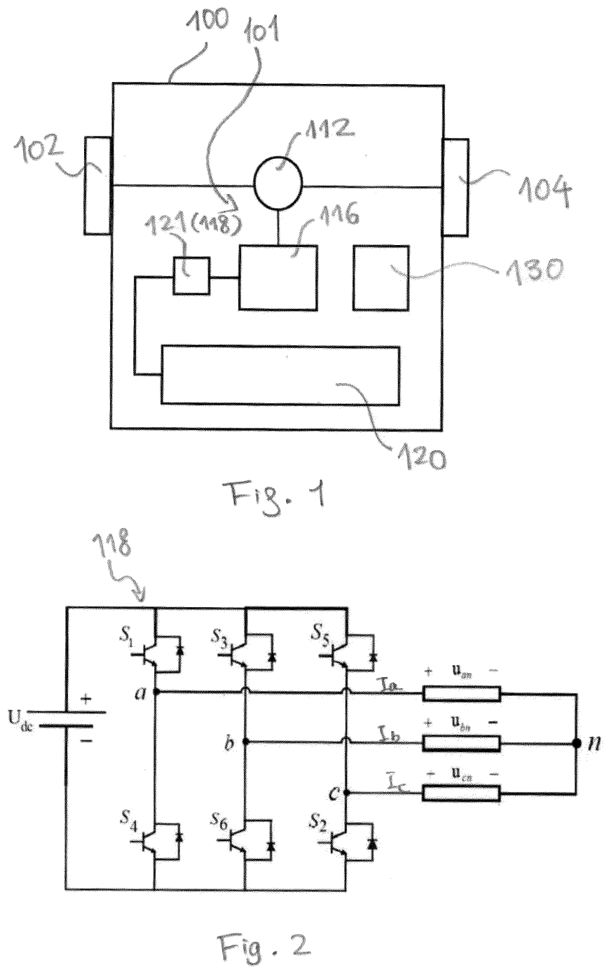

The converter device 121 has an inverter unit 118 configured to convert a DC input voltage U_{dc} supplied by the drive battery 120 into an AC output voltage having a plurality of phase voltages by switching a plurality of semiconductor-based power switches S1-S16 integrated in the inverter unit 118. FIG. 2 is a schematic wiring diagram of a purely exemplary constructional type of inverter unit 118. Power switches S1-S6 are wired in accordance with a half-bridge topology. Purely by way of example, a B6 bridge topology is selected in the present instance in order to enable a three-phase AC output voltage with three phase voltages Uₐₙ, U_{bn}, U_{cn}. Three high-side power switches S1, S3, S5 form a high-side device, and three low-side power switches S2, S4, S6 form a low-side device. The associated phase is contacted where the high-side device and low-side device are connected to one another. When the high-side power switches and low-side power switches S1-S6 are alternately opened and closed with a predetermined duty cycle, the desired phase voltage Uₐₙ, U_{bn}, U_{cn} appears at the phase which is applied to the associated coil winding of the electric machine 116, particularly of a stator of the electric machine 116. In this way, time varying sinusoidal phase voltages Uₐₙ, U_{bn}, U_{cn} can be generated at the individual phases of the electric machine 116 by a pulse width modulation (PWM) of the power switches S1-S6. The actuation of the converter device 121 or of the inverter unit 118 is carried out by an apparatus 130 which is formed as a control device. The control device can have an electronic control unit (ECU) of the vehicle or, alternatively, can be integrated in the ECU or, as another alternative, can be signally connected to the ECU.

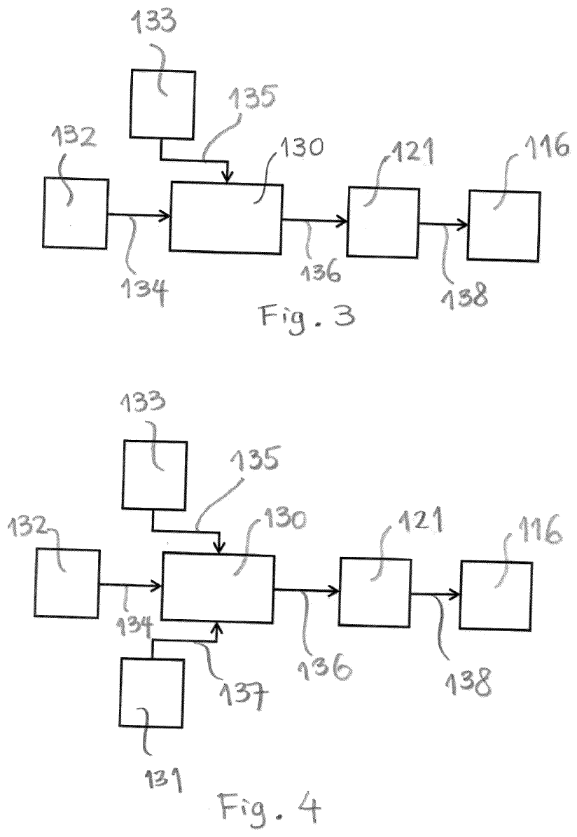

The apparatus 130 is configured to carry out a method or control method for the electric axle drive system 101. FIG. 3 shows a schematic diagram of the method. The method serves to control the electric machine 116 for purposes of heat generation in order to cover a heat requirement of a vehicle component, in this case, by way of example, the drive battery 120. A standstill signal 135 which indicates a standstill of the vehicle 100 is first sent to the apparatus 130 by a standstill signal transmitter 133. The standstill signal is generated after the vehicle 100 has been brought to a standstill. The standstill signal is preferably not generated until after a stable standstill has been determined at least for a predefined period of time.

The apparatus 130 additionally receives a heat requirement signal 134, which is generated by a heat requirement detection unit 132. The heat requirement detection unit 132 is configured, for example, to monitor a temperature of the drive battery 120. Alternatively or additionally, the temperature of the environment in which the vehicle 100 is located and/or the temperature of the vehicle interior (e.g., when the vehicle component 120 comprises a vehicle interior heating device) can be monitored. When the monitored temperature lies below a predefined lower limit, the heat requirement signal 134 can be generated and conveyed to the apparatus 130. Alternatively or additionally, the heat requirement signal 134 can be generated every time the vehicle 100 is started again. The heat requirement signal 134 is preferably generated and sent to the apparatus 130 after a time period during which the vehicle 100 is out of operation, particularly the time between the last immobilization and the restarting of the vehicle 100, has reached a predefined threshold value. This step serves to precondition the drive battery 120 before initiating driving operation in order to adjust and optimize the functionality of the drive battery 120 to the desired driving operation. The heat requirement signal 134 can be a temporal point signal, a temporal (e.g., periodic) signal sequence or, alternatively, a temporal continuous signal.

In response to the received heat requirement signal 134, the apparatus 130 generates a control signal 136 to energize the electric machine 116 for purposes of heat generation. To this end, the control signal 136 is impressed into the inverter unit 118, whereupon the high-side power switches S1, S3, S5 and the low-side power switches S2, S4, S6 are opened and/or closed (for example, alternately) according to a switching pattern. In the configuration shown schematically in FIG. 3, the electric machine 116 is a permanent magnet excited synchronous machine, for example. The phase currents Iₐ, I_{b}, I_{c} which are generated by switching the inverter unit 118 based on the DC input voltage U_{dc} and which together form an AC current signal 138 are fed into the coil windings of the stator of the electric machine 116 (or into the stator windings) associated with the respective phases.

Alternatively, the electric machine 116 can be formed as an externally excited synchronous machine (not shown in more detail). In this case, the converter device 121 comprises, in addition to the inverter unit 118, a DC/DC converter unit for energizing the rotor of the electric machine 116. In response to the received heat requirement signal 134, the apparatus 130 generates, in addition to the control signal 136 for the inverter unit 118, a further control signal for the DC/DC converter unit which correspondingly generates a DC current signal based on the further control signal and feeds it into the rotor or coil winding thereof.

The actuation of the converter device 121, particularly the inverter unit 118, serves to energize the electric machine 116 in such a way that a thermal load difference between individual phases of the electric axle drive system 101 lies below a predefined threshold. The power switches S1-S6 of the converter device 121 or inverter unit 118 are alternately opened and closed such that phase currents result in which the individual phases are uniformly thermally loaded. To this end, the thermal loading of the various phases is preferably determined on the machine side and/or on the converter side or inverter side. As is shown purely schematically and by way of example in FIG. 4, this is carried out by a determination unit 131 which preferably determines, particularly measures and/or calculates, the copper losses in the electric machine for the machine-side thermal loads or the switching losses or conduction losses in the converter device 121 or inverter unit 118 for the converter-side/inverter-side thermal loads of the phases. The determination unit 131 can be integrated in the apparatus 130 according to the invention or, alternatively, can be designed as a separate component. The thermal loads determined in this way are conveyed to the apparatus 130. A total thermal load of the electric axle drive system 101 is obtained from the thermal loads determined in this way on the machine side and/or inverter side. Subsequently, the inverter unit 118 is actuated such that the total thermal load corresponds to a reference value. The reference value describes the required total thermal load of the electric axle drive system 101 preferably corresponding to the detected heat requirement. To this end, a difference between an actual value and the reference value of the total thermal load can be determined. Based on the difference between the actual value and reference value, the power switches S1-S6 of the converter device 121 or inverter unit 118 are correspondingly switched and, consequently, the phase currents Iₐ, I_{b}, I_{c} are adapted until the reference value is reached.

Further, a thermal load difference between individual phases of the electric axle drive system 101 (on the machine side and/or on the converter side or inverter side) is minimized by switching the power switches S1-S6. A difference of thermal loads between the individual phases is determined as thermal load difference. This thermal load difference is preferably minimized, further preferably reduced to and held at zero, by a controlled rotation of a current phasor in a dq coordinate system corresponding to the phase currents Iₐ, I_{b}, I_{c} of the electric machine 116. The minimizing process involves switching the power switches S1-S6 according to a corresponding suitable switching pattern.

The switching pattern for the power switches S1-S6 is selected in such a way that the rotational frequency (angular frequency) of the generated stator magnetic field lies below a predefined first threshold frequency. This enables a low angular frequency for the adjusted stator magnetic field so that the torque acting on the rotor (or on the motor shaft of the electric machine 116) is controlled to a comparatively low level. In addition, this allows a uniform (symmetrical) thermal loading of the multi-phase system in the electric machine 116 and in the converter device 121 or inverter unit 118. In this regard, copper losses on the machine side occur substantially primarily in the stator windings. This constitutes a further advantage because the stator can generally be cooled appreciably better at standstill than, e.g., the rotor, particularly using an oil cooling of the electric machine 116, and the copper losses in the system overall can therefore be extensively dissipated. Contemplated values for the predefined first threshold frequency are, for example, less than 1 Hz, preferably less than 0.5 Hz, further preferably less than 0.1 Hz, even further preferably less than 0.01 Hz, still further preferably less than 0.005 Hz.

Alternatively or additionally, the converter device 121, particularly the inverter unit 118, can be actuated to generate an AC output voltage (phase voltage Uₐₙ, U_{bn}, U_{cn}) based on a DC input voltage U_{dc}, which AC output voltage corresponds to a voltage phasor rotating relative to a rotor coordinate system with a second rotational frequency, which second rotational frequency lies below a predefined second threshold frequency.

Alternatively or additionally, the converter device 121, particularly the inverter unit 118, can be actuated to generate the AC phase currents Iₐ, I_{b}, I_{c} based on the DC input voltage U_{dc}, which AC phase currents Iₐ, I_{b}, I_{c} correspond to a current phasor rotating relative to a dq coordinate system with a third rotational frequency, which third rotational frequency lies below a predefined third threshold frequency.

The heat generated by energizing the electric machine 116 in the converter device 121 and in the electric machine 116 itself, particularly in the stator windings and rotor windings, is delivered to the at least one vehicle component or drive battery 120 in order to meet its heat requirement. For example, the heat is used to precondition the drive battery 120. The heat transfer can be carried out via the coolant circuit of the electric axle drive system 101. In this case, the coolant present in the coolant circuit of the electric machine 116 or of the converter device 121 is heated, whereupon its temperature increases. If the same coolant circuit is used simultaneously to cool the drive battery 120 or, alternatively, is thermally coupled with a separate coolant circuit of the drive battery 120 via a heat exchanger, the heat which is generated according to the invention can be supplied in the same manner as when cooling the drive battery 120 in order to selectively heat the latter for purposes of preconditioning. This also applies analogously to the case in which the at least one vehicle component 120 comprises the vehicle interior heating device or another or further component to be heated.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for controlling an electric machine of an electric axle drive system in an at least partially electrified vehicle, wherein the electric axle drive system has a converter configured as an inverter unit and arranged upstream of the electric machine for voltage conversion, the method comprising:
detecting a standstill of the vehicle;
receiving a heat requirement signal of the vehicle, which is at a standstill, wherein the heat requirement signal indicates a heat requirement of at least one vehicle component of the vehicle; and
actuating the converter to energize the electric machine such that a total thermal load of the electric axle drive system corresponds to a predefined reference value and a thermal load difference between individual phases of the electric axle drive system is minimized.

2. The method according to claim 1, further comprising:
detecting thermal loads of the individual phases on a machine side and/or on a converter side or an inverter side;
controlling the total thermal load with the predefined reference value by switching a plurality of power switches of the converter;
determining a difference between the detected thermal loads of the individual phases on the machine side and/or converter side or inverter side as the thermal load difference; and
minimizing the thermal load difference by a controlled rotation of a current phasor in a dq coordinate system, which current phasor corresponds to the phase currents of the electric machine.

3. The method according to claim 2, wherein copper losses for machine-side thermal loads and/or switching losses and/or conduction losses for converter-side or inverter-side thermal loads of the individual phases are measured and/or calculated.

4. The method according to claim 1, wherein the converter is actuated to generate a stator magnetic field which has a first rotational frequency which lies below a predefined first threshold frequency.

5. The method according to claim 4, wherein the first threshold frequency is less than at least one of: 1 Hz, 0.5 Hz, 0.1 Hz, 0.01 Hz, and 0.005 Hz.

6. The method according to claim 1, wherein the converter is actuated to generate an AC output voltage based on a DC input voltage, which AC output voltage corresponds to a voltage phasor rotating relative to a rotor coordinate system with a second rotational frequency, wherein the second rotational frequency lies below a predefined second threshold frequency.

7. The method according to according to claim 2, wherein the converter is actuated to generate a plurality of AC phase currents based on a DC input voltage, which AC phase currents correspond to a current phasor rotating relative to the dq coordinate system with a third rotational frequency, wherein the third rotational frequency lies below a predefined third threshold frequency.

8. The method according to claim 1, further comprising supplying the heat created when energizing the electric machine to the at least one vehicle component, wherein the at least one vehicle component comprises a drive battery and/or a vehicle interior heating device.

9. An apparatus, configured as a control device, for controlling an electric machine of an electric axle drive system in an at least partially electrified vehicle, wherein the electric axle drive system has a converter device, configured as an inverter unit and arranged upstream of the electric machine for voltage conversion, wherein the apparatus is configured to:
detect a standstill of the vehicle;
receive a heat requirement signal of the vehicle, which is at a standstill, wherein the heat requirement signal indicates a heat requirement of at least one vehicle component of the vehicle; and
actuate the converter device to energize the electric machine such that a total thermal load of the electric axle drive system corresponds to a predefined reference value and a thermal load difference between individual phases of the electric axle drive system is minimized.

10. An electric axle drive system for an at least partially electrified vehicle comprising:
an electric machine;
a converter device, configured as an inverter unit and arranged upstream of the electric machine for voltage conversion; and
the apparatus according to claim 9.

11. An at least partially electrified vehicle with an electric axle drive system according to claim 10.

12. A nontransitory machine-readable storage medium comprising commands which, when executed by a computer, cause the computer to:
detect a standstill of a vehicle;
receive a heat requirement signal of the vehicle, which is at a standstill, wherein the heat requirement signal indicates a heat requirement of at least one vehicle component of the vehicle; and
actuate a converter device to energize an electric machine such that a total thermal load of an electric axle drive system corresponds to a predefined reference value and a thermal load difference between individual phases of the electric axle drive system is minimized.

13. Method according to claim 2, further comprising minimizing the thermal load to zero.
